(19) United States
(12) Patent Application Publication
(10) Pub. No.: US 2022/0364408 A1
(43) Pub. Date: Nov. 17, 2022

(54) CLIMATE ADAPTIVE GLASS ENVELOPE FOR BUILDING

(71) Applicant: Oren Aharon, Haifa (IL)

(72) Inventor: Oren Aharon, Haifa (IL)

(21) Appl. No.: 17/316,757

(22) Filed: May 11, 2021

(51) Int. Cl. E06B 7/10; E04B 2/96

(52) U.S. Cl. CPC E06B 7/10; E04B 2/96; E06B 2007/023

(57) ABSTRACT

Glass buildings are characterized by contradictory requirements—high visibility and high insolation levels. Transparency will allow sun radiation into the building, while isolation will prevent heat to be ventilated through same windows. This creates a greenhouse effect during summer, leading to excessive air conditioning load. As a result, leading architects and engineers are calling for all-glass skyscrapers to be banned. The disclosed art offers an alternative glass envelope which adapts its U-Value to climate changes, by a special aluminum frame which dissipates the heat when necessary. The proposed system is sealed and the adaptation of the envelope U-Value is achieved by circulating enclosed air into the aluminum frame, significantly increasing its heat dissipation characteristics. The disclosed art overcomes most drawbacks of prior art, offering a solution with superior U-value isolating during wintertime and cooling during summertime. SHGC will be controlled by a triple glazed configuration with two parallel cavities.

### BACKGROUND OF THE INVENTION

### 1, Field of Invention

The present invention relates to a climate adaptive system to be preferably implemented in high-rise buildings' external envelopes, although other applications such as urban housing or green houses can take advantage of this technology.

### 2. Description of the Related Art

Glass-fronted offices and high-rise buildings are very popular and proliferate in cities, shopping centers, industrial parts and enjoy a high level of acceptance with architects all over the world. Due to their immaculate aesthetics and their basic glass design which lets in a lot of natural light and great views from building façade, they are highly accepted. The basic design is to cover the building with a transparent curtain wall which has a great impact on inhabitants and outside population. Said curtain wall is usually based on a hermetical double-glazing design, although lately triple-glazing design is getting more and more popular. Once installed, those curtain walls are passive and do not offer any climate adaptation. But the sunlight which also brings heat to an environment which is heat-isolated, with no natural way to dissipate this heat load will bring record breaking greenhouse effect into the building and its inhabitants. For example, heat removing has to rely on building's air conditioning, which has to be designed according to peak heat waves and generates excessive energy consumption.

The invention discloses an art applicable to buildings which allows the building's envelope to behave similar to skin-like performance, ameliorating the adverse heating and greenhouse effect in building interior. In a previous patent U.S. Pat. No. 10,181,816B2, a technology for a triple-glazed adaptive curtain wall was disclosed. However, its performance was limited because of the fact that it was using glass-only design without taking the advantage of possible active frame which potentially will increase its effectiveness due to the fact that aluminum or other metal frames can be made much more effective since they have a heat transfer coefficient which is many times higher (hundreds of times when compared with glass). It is our goal to offer a significantly increased climate adaptation device for building envelopes with specially designed metallic frames. The invention concerns a transparent module to be installed as a building envelope with built-in special aluminum frame with superior adjustable U-value increasing its range. Adjusting the U-value is enhanced by directing enclosed air in said transparent module to flow through the aluminum or high heat-transfer material frame to be able to remove or absorb heat from environment in a high-rate. Preferable this technology will be applied to triple glass type of curtain walls or solar roof technologies. As for the triple-glass configuration, it has the capability to control the heat transfer to the building interior, directing heat to the interior when it's cold and expelling heat when it's hot. This is achieved by controlling the solar heat coefficient of the glazed façade using the circulation technology disclosed in our art.

### SUMMARY

The proposed invention is to provide the building industry a better solution for constructing livelihood environment with low energy consumption and high level of well-being to the inhabitants. Glass façade has an architectural advantage as well as fast mechanized building technologies but lacks the capability to actively adapt itself to climate changes.

Nowadays, one of the biggest concerns of policymakers, business owners and regulators is to decrease the carbon footprint, especially in the building sector. Although new materials and technologies are widely used in this sector, there are limited possibilities of efficiency measures to be applied, due to the fact that the building itself is passive and does not interact with the environment. This means that some characteristics of the buildings, such as insulation values are constant, especially when dealing with the building's facades. Moreover, buildings' facades are rarely used to harvest energy because of low architectural aesthetics. Ideally, customers need to create a building that will interact with the environment similar to the human skin—adapting itself to changes and absorbing energy directly from the sun. This will meet current customer requirements and will potentially help decrease the carbon footprints.

The presented art innovation is offering a new kind of heat-adaptive curtain wall or roof element, with built-in sensors, frame and air-circulation fans encapsulated into a hermetically sealed easy-to-mount curtain wall. To achieve maximum isolation, current technology uses double-glazing with a stationary air layer in-between; this is optimal for high and static U-value or isolation factor, but is not adequate for external and internal environments that are always changing. Our device will have a microcontroller to change the curtain wall U-value by applying forced airflow within the hermetically sealed double-cavity with special design for directing airflow through the frame, significantly increasing the span of possible U-value changes. This will change the U-value and will direct excessive heat to the building interior when needed. Moreover, by adapting the U-value it is possible to interact with the environment and draw or expel heat from the environment, according to the needs.

Implementing the technology will ultimately translate into an energy efficient building, which will automatically adapt its heat transfer to the environment according to building's momentarily and long-term needs.

The disclosed art is characterized as smart climate adaptive building shell and is applicable for existing buildings or for renovation projects. The building's curtain wall heat resistance is usually denoted as R, and for calculation purposes, several heat resisting barriers are regarded as series circuit.

Heat transfer through a surface like a window can be calculated as:

q=U A dT, where q is total heat transfer, usually in [Watt], and U is the overall heart transfer coefficient and R equals 1/U.

A is naturally the Area of the surface and dT is the temperature difference between input and output.

The overall heat transfer for a multiple-layered device will be

1/UA=1/hᵢₙAᵢ+Σ(sₙ/kₙAₙ)+1/hₒᵤₜAₒ, where

Kₙ=thermal conductivity of material

sₙ=thickness of conductive area

For a specific application where A is constant,

1/U=1/hᵢₙ+Σ(sₙ/kₙ)+1/hₒᵤₜ

For our application, by circulating the air into the frame, we change the U-value or 1/U=R due to the increased heat transfer by air. The aluminum frame, where the air is directed to, has a heat transfer of 205-250 W/(m K), compared to glass which is about 1 W/(m K), thus heat will be dissipated efficiently at the frame, reducing the heat transfer resistance of our device.

Multi-layered climate adaptive glass envelope for building—Heat Transfer Thermal Resistance can be expressed as:

R=1/U

The glass envelope is split between air separations and glass surfaces, wherein the air separation significantly changes its resistance when circulated.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a design representation of the proposed system with built-in metal frame and two cavities.

FIG. 2 is a representative flow simulation of air in glass cavity circulated into the metal frame.

FIG. 3 displays the system wherein one metal frame is removed for better understanding the parts which are enclosed by this metal frame.

FIG. 4 is a high-resolution flow diagram similar to FIG. 2 and based on a computer simulation of our system.

FIG. 5 is a typical layout of the proposed climate adaptive glass envelope with two cavities and three glass surfaces.

FIG. 6 is a representation of the resistance of each surface of proposed system.

### DETAILED DESCRIPTION OF THE DRAWINGS

In the following disclosed art, a glazed wall based on at least one double-glazed cavity encapsulated on its perimeter by a preferable metal frame with high thermal conductivity and built-in airduct, having at least one electrical fan device that when activated creates an airflow circulating the air from the double-glazed cavity through said frame airduct. Said airflow will move heat from the inner glass cavity through said metal frame and expel it to the environment, similarly it can be used to absorb heat from environment to heat the interior. For increased efficiency, the metal frame has built-in heat transfer fins, offering larger area exposed to the airflow.

For high performance applications, two cavities are mounted together to create a triple glass isolating curtain wall, each having its own encapsulating frame and air controlling features.

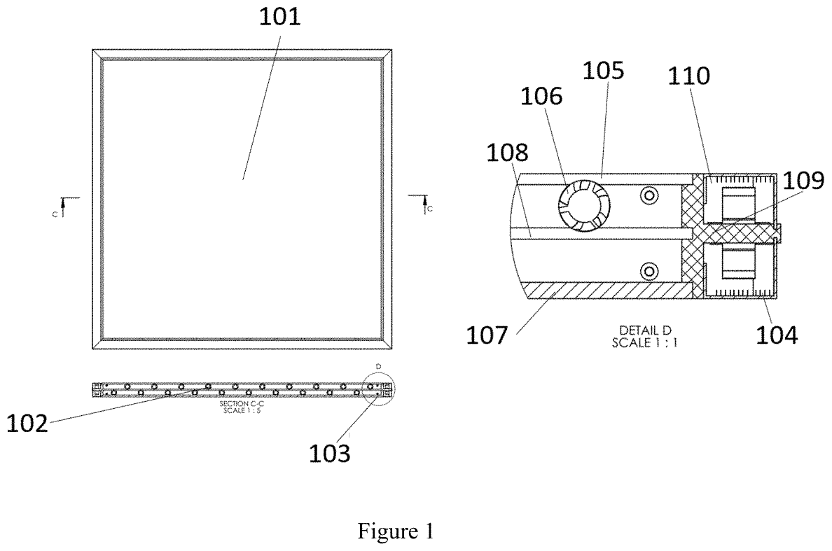

FIG. 1 shows a graphical representation including its Aluminum frame, facilitating airflow in between the glass cavities and through the Aluminum frame for recirculation. The Aluminum frame has a crucial effect on the isolation of our triple window since its heat transfer coefficient compared to glass is 200 times higher. Moreover, being thin when compared to glass, the overall heat transfer capability could be almost 1000 times better than the glass substrate. When high heat isolation is required, air doesn't circulate and is stationary within the window cavity and the Aluminum frame. By activating the small fans, air circulation starts and then isolation of windows drops significantly with substantial effect of the frame which is the main heat conducting to environment. The figure shows a typical full window according to my invention, including glass and frame members and is denoted as 101. A cross-section of said window is denoted as 102 and shows the inner parts of preferable configuration. In order to further understand the system, a detailed view of a small section is displayed. 103 is a cross-section of the tubular Aluminum frame and it's facing the interior of the building. 104 is a second tubular frame isolated from the interior frame by 109. 105 is the interior transparent glass of said window and 107 is the exterior of said window. 108 creates two cavities using an additional transparent glass. 106 is a typical fan mounted on the frame and it is a part of multiple fans mounted along the frame, on its lower and upper sides. The fans are used for circulating the air enclosed into the said cavities through the frame and the cavity itself, significantly reducing the isolation of the window by airflow heat transfer. 110 represents cooling fins built-in into the said metal frame enclosures.

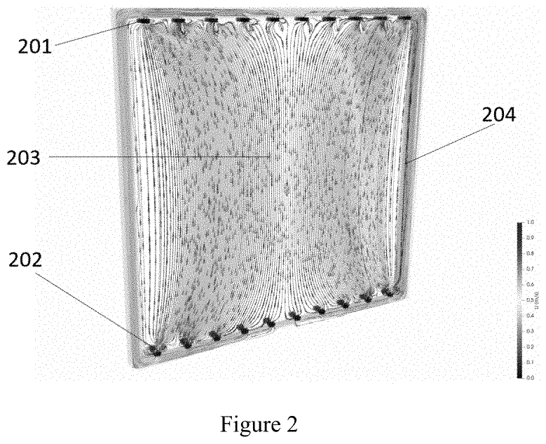

FIG. 2 is a schematic representation of proposed triple glazed window or curtain wall which consists of two cavities attached to each other, each cavity featuring its own circulating fans. 201 represents the fan mounted on the upper Aluminum frame cavity and it sucks the air into the Aluminum cavity. This air travels at high speed through the frame and is denoted as 204. When air reaches the lower part of Aluminum frame, it is blown upwards by miniature fans denoted as 202. The airflow lines within the transparent cavity are denoted as 203.

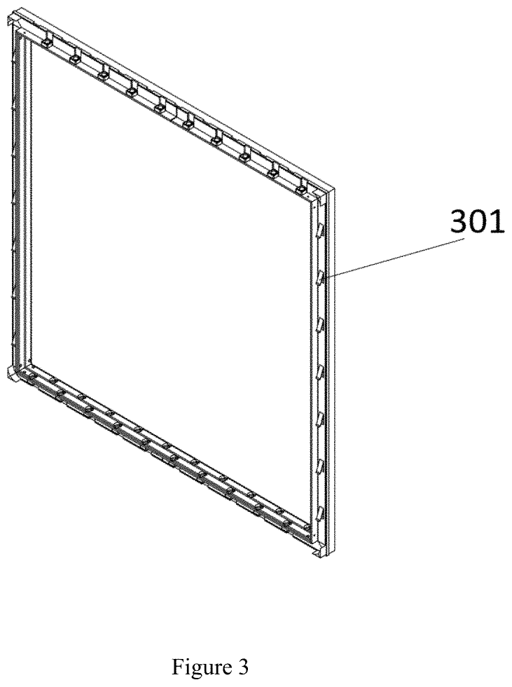

FIG. 3 is yet another schematic representation of the proposed module, wherein the external enclosure of the frame was removed for better observation of its inner assembly. Here the small orifices denoted as 301 are designed in such a way that they can connect between inner and outer frame to further reduce the system's isolation by recirculating air between the frames. The 301 openings are closed when this airflow is unnecessary.

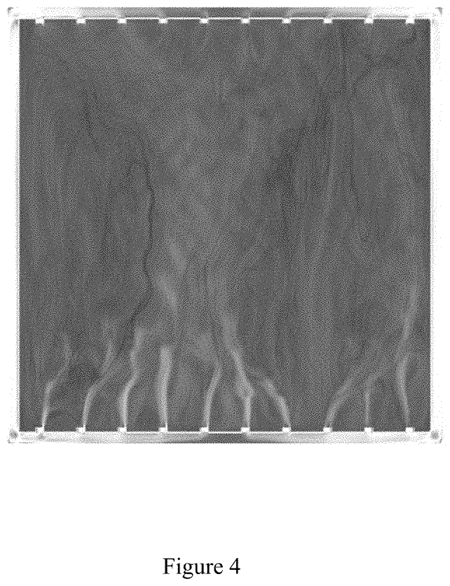

FIG. 4 is a high-resolution flow diagram similar to FIG. 2 and based on a computer simulation of our system.

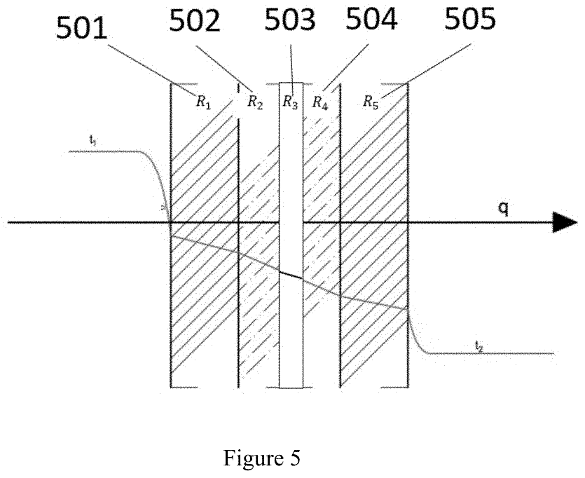

FIG. 5 is a representation of the proposed climate adaptive glass part of the envelope without the Aluminum frame, and describes the heat flow when the air is not circulated. 501 denotes the first glass element facing the interior of the room. 502 denotes the air in first cavity in a stationary phase. At this phase the air is a very good isolator and it typically has 0.022 [kcal(IT)/(h m K)]. When circulated, this changes significantly and actually will convect heat from 502 cavity, actually cooling the system by convection. This type of calculation is usually done by simulation, where the results are represented in previous drawings. 503 denotes another glass separation which may be transparent or tinted. 504 denotes a second cavity wherein the air may be circulated or not, depending on external activation. 505 is the outside glass separation of system.

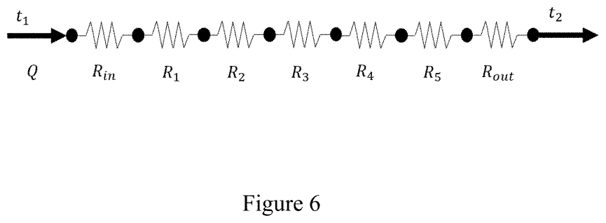

FIG. 6 is a representation of heat transfer using a resistance model similar to Ohm's law, which is very popular in electronic, wherein each resistance denotation represents the cavities disclosed by FIG. 5.

The features of the invention disclosed in the specification, in the drawings and in the claims can be essential for implementation of the invention, both individually and in any combination.

What is claimed is:

1. A glass curtain wall module comprising of:
at least one double-glazed cavity encapsulated on its perimeter by a preferable metal frame with high thermal conductivity and built-in airduct;
at least one electrical fan device that when activated creates an airflow circulating the air from the double-glazed cavity through said frame airduct;
the airflow will move heat from the inner glass cavity through said metal frame and expel it to the environment, similarly it can be used to absorb heat from environment to heat the interior; and
said metal frame has heat transfer fins increasing its heat transfer coefficient;

2. A glass curtain wall according to claim 1, wherein two cavities are mounted together to create a triple glass isolating curtain wall, each having its own encapsulating frame and air controlling features
